(19) United States
(12) Patent Application Publication
(10) Pub. No.: US 2022/0234170 A1
(43) Pub. Date: Jul. 28, 2022

(54) TOOL WITH SURFACES WITH A COMPRESSIVE SURFACE STRESS LAYER

(71) Applicant: Snap-on Incorporated, Kenosha, WI (US)

(72) Inventors: Ottoleo Kuter-Arnebeck, Kenosha, WI (US); David T. Ross, Kenosha, WI (US)

(73) Assignee: Snap-on Incorporated, Kenosha, WI (US)

(21) Appl. No.: 17/158,551

(22) Filed: Jan. 26, 2021

(51) Int. Cl. B24C 1/10; B25B 13/46

(52) U.S. Cl. CPC B24C 1/10; B25B 13/463

(57) ABSTRACT

A tool, such as a ratchet tool, including a head portion having a cavity adapted to at least partially enclose a ratchet gear for providing torque to a working piece. Surfaces of the cavity and/or ratchet gear are provided with a compressive residual stress layer by a cold working process, such as, for example, shot peening.

### TECHNICAL FIELD OF THE INVENTION

The present invention relates generally to tools, and more particularly to ratchet tools having surfaces provided with a compressive surface stress layer by a cold working process.

### BACKGROUND OF THE INVENTION

Currently many types of ratchet tools are known and used, such as wrenches and/or screwdrivers, or the like. These tools typically include a ratchet mechanism disposed in a cavity of a head portion of the tool. The ratchet mechanism typically includes a pawl and a ratchet gear having a drive portion engageable with a work piece, for example, a bolt head. A first drive direction may be selected, typically using a manually actuable portion, commonly referred to as a reversing lever, so that use of the tool provides torque when engaged with the work piece and rotated in a first direction while slipping or ratcheting when rotated in a second direction. A second drive direction may be selected using the reversing lever that is opposite the first drive direction, and that provides torque and ratcheting in the opposite directions.

In operating a dual pawl mechanism the drive direction for the drive portion is dependent on which of two pawls is engaged. This mechanism typically effects the engagement of one pawl and the disengagement of a second pawl via a pawl carrier coupled to a reversing lever. However, certain areas of the ratchet tool experience significant cyclic loading during use. Thus, wear and fatigue can occur in these areas experiencing high loading and/or stress concentration. Typically, ratchet tools are strengthened using advanced metallurgy or by adjusting the design by increasing the radius of corners or using other known transitions to reduce stress concentrations. However, increasing the radius and using other transitions results in an increase in the size of the tool and/or decreases the amount of space in the cavity of the head portion of the tool. Additionally, advanced metallurgy processes increase manufacturing costs and complexity.

### SUMMARY OF THE INVENTION

The present invention relates broadly to a tool, such as a ratchet tool, including a head portion with a cavity that is adapted to at least partially enclose a ratchet mechanism that includes a pawl and a ratchet gear having a drive portion engageable with a work piece. The ratchet tool has one or more surfaces provided with a compressive residual stress layer via a cold working process, such as, for example, shot peening. The present invention results in a ratchet tool with improved wear and fatigue life without having an increased size and/or expensive manufacturing costs compared to current solutions.

In an embodiment, the present invention broadly comprises a ratchet tool. The ratchet tool includes a head portion having a cavity adapted to at least partially enclose components for providing torque to a working piece. Surfaces of the cavity are provided with a compressive residual stress layer.

In another embodiment, the present invention broadly comprises a ratchet gear for a ratchet tool. The ratchet gear is adapted to be rotatably disposed in a cavity of the ratchet tool and includes a body portion, a toothed portion adapted to selectively engage with a pawl, and a drive portion that projects from the body portion and is adapted to project outwardly from the cavity to engage a work piece. Surfaces of the ratchet gear are provided with a compressive residual stress layer.

In another embodiment, the present invention broadly comprises a method of manufacturing a ratchet tool having a head portion with a cavity adapted to at least partially enclose a ratchet gear. The method includes cold working surfaces of the cavity to create a compressive residual stress layer.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is an exploded, perspective view of an exemplar tool, according to an embodiment of the present invention.

FIG. 2 is an assembled, perspective view of the tool of FIG. 1.

FIG. 3 is a side view of an exemplar ratchet gear of the tool of FIG. 1.

FIG. 4 is a detailed, top view of a head portion of the tool of FIG. 1.

FIG. 5 is a plot diagram of residual stress as a function of depth from a surface as a result of an exemplary cold working process, such as shot peening.

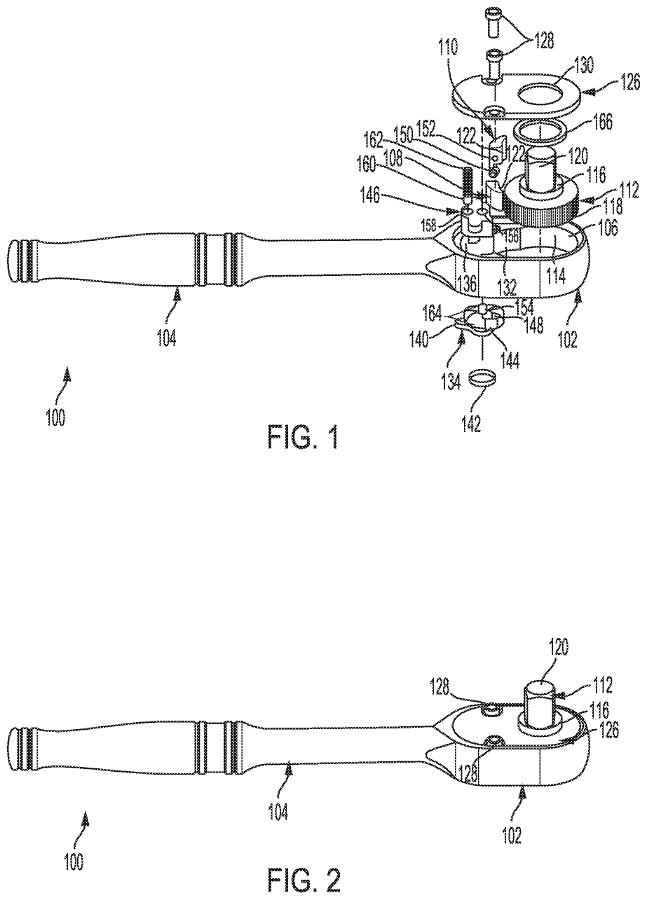

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention broadly includes a tool, such as a ratchet tool, having a head portion with a cavity that is adapted to at least partially contain a ratchet gear. The ratchet tool has surfaces provided with a compressive residual stress layer via a cold working process, such as, for example, shot peening. The present invention results in a ratchet tool with improved wear and fatigue life without having an increased size and/or expensive manufacturing costs compared to current solutions.

Referring to the Figures, an exemplary tool 100, such as, for example, a dual-pawl ratchet wrench, having a head portion 102 and a handle portion 104 is depicted. The head portion 102 includes a cavity 106 for at least partially enclosing components of the tool 100 for providing torque to a working piece (not shown) such as a socket and/or a fastener.

The head portion 102 includes first and second pawls 108, 110 disposed in the cavity 106. The first and second pawls 108, 110 are selectively engageable with a ratchet gear 112 that is operatively engageable with the work piece in a well-known manner. When one of the first and second pawls 108, 110 engages the ratchet gear 112, torque drive is permitted with rotation of the head portion 102 in a first rotational direction while ratcheting occurs with rotation of the head portion 102 in a second rotational drive direction opposite the first rotational drive direction. Conversely, when the other of the first and second pawls 108, 110 is engaged with the ratchet gear 112, torque drive is permitted with rotation of the head portion 102 in the second rotational drive direction while ratcheting occurs with rotation of the head portion 102 in the first rotational drive direction.

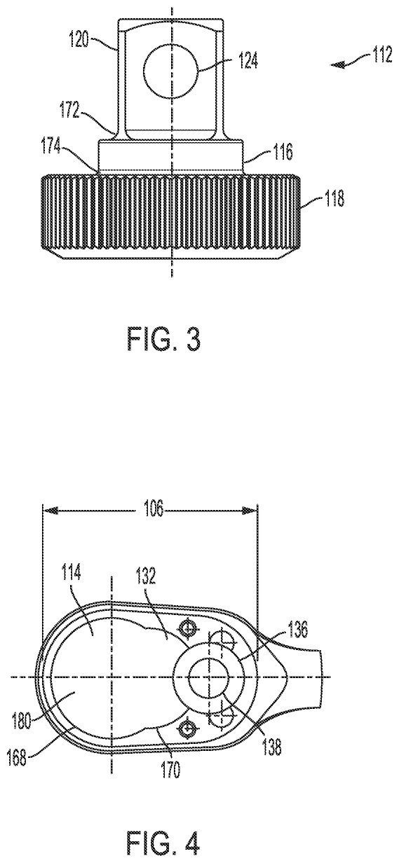

The cavity 106 includes several portions for receiving and at least partially enclosing components of the tool 100 therein. The ratchet gear 112 is received in a first large generally circular portion of the cavity 106, referred to herein as the drive cavity portion 114. The ratchet gear 112 has a generally circular body portion 116 with a toothed portion 118, and a drive portion 120, such as, for example, a drive lug, projecting from the body portion 116. The toothed portion 118 engages with pawl teeth 122 formed on each of the pawls 108, 110 for selective engagement with the pawls 108, 110 to provide torque drive through the drive portion 120 in either of the first and second rotational drive directions. In an embodiment, as illustrated in FIG. 3, the drive portion 120 includes an aperture 124 adapted to allow an outwardly biased ball (not shown) to pass therethrough in a well-known manner.

A cover plate 126 is secured to the head portion 102 to enclose the components of the tool 100 in the cavity 106 in a well-known manner. In an embodiment, the cover plate 126 is retained to the head portion 102 using fasteners 128, such as, for example, screws, rivets, etc. The cover plate 126 includes an opening 130, such as, for example, a circular bore, through which the drive portion 120 projects for operative engagement with the work piece. The opening 130 also defines a bearing surface for the body portion 116 to position the ratchet gear 112.

The first and second pawls 108, 110 are located in a second portion of the cavity 106, referred to herein as the pawl cavity portion 132. The drive cavity portion 114 and pawl cavity portion 130 overlap or communicate to allow the first and second pawls 108, 110 to selectively move into and out of engagement with the toothed portion 118 of the ratchet gear 112.

As will be discussed below, an actuator 134 for selectively engaging and disengaging the first and second pawls 108, 110 with the ratchet gear 112 is provided in a well-known manner. In an embodiment, the actuator 134 is received in a third portion of the cavity 106, referred to herein as the actuator cavity portion 136. A throughbore 138 (FIG. 4) is provided on the head portion 102 to allow the actuator 134 to extend through the head portion 102 so that a lever portion 140 of the actuator 132 is positioned on the outside of the head portion 102 and is adapted to be manually operated to select a torque drive direction by a user. A seal 142 is positioned around the actuator 132 to impede or prevent contaminants from entering the cavity 106 through the throughbore 138. In an embodiment, the actuator 134 is assembled with the head portion 102 by inserting the lever portion 140 into the pawl cavity portion 132 from a first side of the head portion 102, and by extending the lever portion 140 through the throughbore 138 to a second side of the head portion 102, which promotes the ability to utilize the seal 142 for preventing ingress of contaminants. The actuator 134 includes a disc portion 144 sized to prevent complete passage through the opening, so that the actuator 134 can be mounted in only one direction. The seal 142 is compressed and/or held in position between the disc portion 144 and the lever portion 140 of the actuator 134, which is itself held in position by a spacer 146, discussed below, which is held in place by the cover plate 126. The actuator 134 is selectively positioned to select one of the pawls 108, 110 for selecting the torque drive direction. Each of the pawls 108, 110 has a selector post for being manipulated by a recess 148 of the disc portion 144 in a well-known manner.

A bias member 150, such as, for example, a coil spring is positioned between the pawls 108, 110, the ends of the bias member 150 being received and retained by a bore 152 formed in a side of each pawl 108, 110, the respective bores 152 of the two pawls 108, 110 being in an opposed orientation so that the bias member 150 biases the pawls 108, 110 away from each other. In this manner, when the disc portion 144 catches a selector post of one of the pawls 108, 110 to move the respective pawl, the bias member 150 causes the other pawl to shift position. Additionally, the bias member 150 allows the pawl engaged with the toothed portion 118 to cam or deflect away from the toothed portion 118 when the head portion 102 is rotated opposite the selected torque drive direction to allow slippage in that direction, the bias member 150 then forcing the pawl to return to engagement with the toothed portion 118 when rotation of the head portion 102 ceases.

As noted above, the spacer 146 is provided to position the reversing lever actuator 134. The spacer is adapted to receive a post portion 154 of the actuator 134 is received by a spacer bore 156. The post portion 154 forms a pivot, with a generally circular geometry, and the spacer bore 156 is generally circular so as to form a pivot or bearing surface with the reversing lever post 144.

The tool 100 is preferably designed to provide a tactile feel for the user to identify when the actuator 134 is in a proper position for selection of one of the torque drive directions. Towards this end, a ball and detent structure are provided, as is common in devices of this type. More specifically, the spacer 146 has a throughbore 158 into which a ball 160 and biasing member 162, such as, for example, a spring, are inserted. The biasing member 162 contacts and is retained in the throughbore 158 by the cover plate 126. Therefore, as the actuator 134 is rotated, the ball 160 contacts and moves along a surface of the disc portion 144. More specifically, the surface of the disc portion 144 includes a pair of detents or troughs 164 positioned thereon to correspond to proper positions for the ball 160 when the actuator 134 is in the proper position for selection of the first and second drive directions.

A seal 166, such as, for example an o-ring, is disposed between the cover plate 126 and the ratchet gear 112. In an embodiment, the seal 166 is a The body portion 116 positions the seal 166 to keep containments from entering the cavity 106 via the opening 130.

Although the tool 100 is described herein as a dual pawl ratchet wrench, the invention is not limited as such and any ratchet type tool could be used, such as, for example, wrenches, screwdrivers, or the like that typically include a ratchet mechanism disposed in a cavity of a head portion of the tool.

Referring to FIG. 4, one or more surfaces of the tool 100 include a compressive residual stress layer created by a cold working process, such as, for example, shot peening. The compressive residual stress layer can be up to a depth of 0.02 inches and at least through the first 0.002 inches. In an embodiment, a sidewall forming the periphery of the cavity 160 includes a compressive residual stress layer created by a cold working process, such as, for example, shot peening. In another embodiment, the drive cavity edge 168 and/or a pawl cavity edge 170 includes a compressive residual stress layer created by a cold working process, such as, for example, shot peening. The drive cavity edge 168 is where the sidewall of the cavity 160 meets a surface 180 of the head portion 102 that encloses one side of the cavity 160 in the drive cavity portion 114. The pawl cavity edge 170 is where the sidewall of the cavity 160 meets the surface 180 of the head portion 102 that encloses one side of the cavity 160 in the pawl cavity portion 132. In another embodiment, the surface 180 of the head portion 102 that encloses one side of the cavity 160 includes a compressive residual stress layer created by a cold working process, such as, for example, shot peening.

In another embodiment, one or more surfaces of the ratchet gear 112 include a compressive residual stress layer created by a cold working process, such as, for example, shot peening. The compressive residual stress layer can be up to a depth of 0.02 inches and at least through the first 0.002 inches. As described above and referring to FIG. 3, the ratchet gear 112 includes the body portion 116, toothed portion 118, drive portion 120, and aperture 124. A first radius 172 transitions from the drive portion 120 to the body portion 116, and a second radius 174 transitions from the body portion 116 to the toothed portion 118. In an embodiment, the surface of the ratchet gear 112 include a compressive residual stress layer created by a cold working process, such as, for example, shot peening. In another embodiment, the toothed portion 118 may include a compressive residual stress layer created by a cold working process, such as, for example, shot peening. In another embodiment, the respective surfaces of the first radius 172 and/or the second radius 174 may each include a compressive residual stress layer created by a cold working process, such as, for example, shot peening. In another embodiment, the surface of the drive portion 120 may include a compressive residual stress layer created by a cold working process, such as, for example, shot peening.

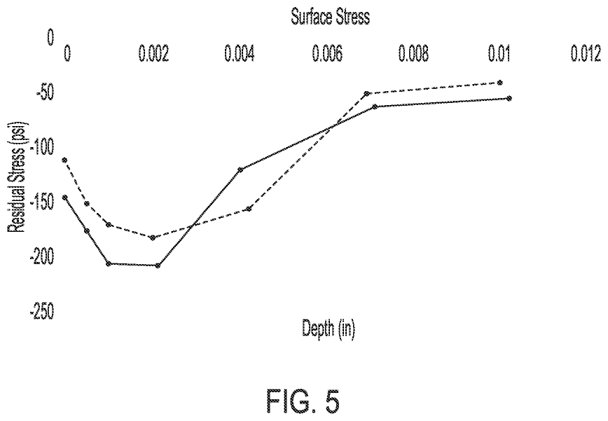

An example of compressive residual stress plotted as a function of depth from the surface is illustrated in FIG. 5. The plot shows the compressive residual stress at various depths from a surface as a result of shot peening the surface.

An exemplary method of manufacturing an exemplary tool, such as the tool 100 is described hereinbelow. For example, the tool 100 including a head portion 102 having a cavity 160 adapted to at least partially enclose components of the tool 100 including a ratchet gear 112 is provided.

One or more surfaces of the cavity 160 are cold worked, such as, for example, by shot peening, thereby creating a compressive residual stress layer. The surfaces can be cold worked to have a compressive residual stress layer up to a depth of 0.02 inches and at least through the first 0.002 inches. In an embodiment, the sidewall forming the periphery of the cavity 160 includes a compressive residual stress layer created by a cold working process, such as, for example, shot peening. In another embodiment, the drive cavity edge 168 and/or the pawl cavity edge 170 include a compressive residual stress layer created by a cold working process, such as, for example, shot peening. In another embodiment, the surface 180 includes a compressive residual stress layer created by a cold working process, such as, for example, shot peening.

One or more surfaces of the ratchet gear 112 are cold worked, such as, for example, by shot peening, thereby creating a compressive residual stress layer. The surfaces can be cold worked to have a compressive residual stress layer up to a depth of 0.02 inches and at least through the first 0.002 inches. In an embodiment, the entire ratchet gear 112 is cold worked, such as, for example, by shot peening, thereby creating a compressive residual stress layer. In another embodiment, the toothed portion 118 is cold worked, such as, for example, by shot peening, thereby creating a compressive residual stress layer. In another embodiment, the first radius 172 and/or the second radius 174 are cold worked, such as, for example, by shot peening, thereby creating a compressive residual stress layer. In another embodiment, the drive portion 120 is cold worked, such as, for example, by shot peening, thereby creating a compressive residual stress layer.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A ratchet tool comprising:
a head portion having a cavity adapted to at least partially enclose components for providing torque to a working piece,
wherein surfaces of the cavity include a compressive residual stress layer.

2. The tool of claim 1, wherein the compressive residual stress layer is a depth between about 0.002 and 0.02 inches.

3. The tool of claim 1, wherein the compressive residual stress layer is created by shot peening.

4. The tool of claim 1, wherein a sidewall forming a periphery of the cavity includes the compressive residual stress layer.

5. The tool of claim 1, wherein a head portion surface that encloses one side of the cavity includes the compressive residual stress layer.

6. The tool of claim 1, wherein the cavity includes a drive cavity portion, a pawl cavity portion, and an actuator cavity portion.

7. The tool of claim 6, wherein a drive cavity edge includes the compressive residual stress layer.

8. The tool of claim 6, wherein a pawl cavity edge includes the compressive residual stress layer.

9. The tool of claim 6, further comprising a ratchet gear rotatably disposed in the drive cavity portion and having a drive portion that projects outwardly from the cavity and a toothed portion, wherein surfaces of the ratchet gear have the compressive residual stress layer.

10. A ratchet gear for a ratchet tool, wherein the ratchet gear is adapted to be rotatably disposed in a cavity of the ratchet tool, comprising:
a body portion;
a toothed portion adapted to selectively engage with a pawl; and
a drive portion that projects from the body portion and is adapted to project outwardly from the cavity to engage a work piece,
wherein surfaces of the ratchet gear have a compressive residual stress layer.

11. The ratchet gear of claim 10, wherein the compressive residual stress layer is created via shot peening.

12. The ratchet gear of claim 10, further comprising a first radius that transitions from the drive portion to the body portion, and a second radius that transitions from the body portion to the toothed portion.

13. The ratchet gear of claim 12, wherein the first radius includes the compressive residual stress layer.

14. The ratchet gear of claim 12, wherein the second radius includes the compressive residual stress layer.

15. The ratchet gear of claim 10, wherein the toothed portion includes the compressive residual stress layer.

16. The ratchet gear of claim 10, wherein the drive portion includes the compressive residual stress layer.

17. A method of manufacturing a ratchet tool having a head portion with a cavity adapted to at least partially enclose a ratchet gear, comprising:
cold working surfaces of the cavity to create a compressive residual stress layer.

18. The method of claim 17, wherein the step of cold working surfaces of the cavity includes shot peening the surfaces.

19. The method of claim 17, wherein the step of cold working surfaces of the cavity includes cold working one or more of a sidewall forming a periphery of the cavity and a head portion surface that encloses one side of the cavity.

20. The method of claim 17, wherein the cavity includes a drive cavity portion, a pawl cavity portion, and an actuator cavity portion, and wherein the step of cold working surfaces of the cavity includes cold working one or more of a drive cavity edge and a pawl cavity edge.

21. The method of claim 17, further comprising cold working surfaces of the ratchet gear to create a compressive residual stress layer.
